(19) United States
(12) Patent Application Publication
(10) Pub. No.: US 2013/0247333 A1
(43) Pub. Date: Sep. 26, 2013

(54) INSTRUMENT HANDLE, A DEVICE HAVING THE INSTRUMENT HANDLE, AND A METHOD OF MANUFACTURING THE INSTRUMENT HANDLE

(71) Applicants: Bradley BENDER, Lincoln, RI (US); Ronald RUDOWSKY, Plymouth, MA (US)

(72) Inventors: Bradley BENDER, Lincoln, RI (US); Ronald RUDOWSKY, Plymouth, MA (US)

(73) Assignee: TRI-MEDICS, Foxboro, MA (US)

(21) Appl. No.: 13/489,342

(22) Filed: Jun. 5, 2012

Related U.S. Application Data
(60) Provisional application No. 61/685,658, filed on Mar. 21, 2012.

(51) Int. Cl. B25G 1/00; B29C 45/00

(52) U.S. Cl. 16/430; 264/328.1; 29/527.1

(57) ABSTRACT

A handle for a device, a device, and a method of making a handle for a device, having a blank extending substantially along a longitudinal axis of the device between a distal end and a proximal end of the device are described. The handle includes protrusions situated on at least a portion of the blank, the protrusions being situated over approximately 180 degrees of a cross-section of the blank taken perpendicular to the longitudinal axis.

### CROSS-REFERENCE TO RELATED APPLICATIONS

The present application claims the benefit of U.S. Provisional Patent Application No. 61/685,658, filed on _______, entitled “Non-Slip Tri-Medics© Gator Grip Medical Non-Slip Holder,” which is expressly incorporated herein in its entirety by reference thereto.

The present application is related to U.S. Design Patent Application Serial No. _______, for “A Medical Device,” bearing Attorney Docket No. [11507/9], filed on the even date herewith, which is expressly incorporated herein in its entirety by reference thereto.

### FIELD OF THE INVENTION

The present invention relates to a handle for scissors, forceps, needle holders and other medical instruments, a device having the handle, and a method of manufacturing the handle for medical instruments.

### BACKGROUND INFORMATION

Handles for medical instruments such as scissors, forceps, and needle holders are conventionally formed by forging or by machining, such as, for example knurled handles. However, such manufacturing processes limit the possibilities for surface patterns or grip structures formed on the handles of the medical instruments. Consequently, the limited possibilities for surface patterns or grip structures on handles of medical instruments limit the potential for a secure grip and precise control of the medical instruments when used in medical procedures.

U.S. Pat. Nos. 4,527,331; 6,592,603; and 7,497,867 describe the use of materials, manufacture and cutting efficiencies for improved scissors or forceps devices over conventional self-opening or automatic return scissors or forceps devices.

### SUMMARY

Exemplary embodiments of the present invention provide a handle for medical instruments, a device having the handle, and a method of manufacturing the handle for medical instruments.

According to an exemplary embodiment of the present invention, a handle for a device includes a blank extending substantially along a longitudinal axis of the device between a distal end and a proximal end of the device, and protrusions situated on at least a portion of the blank, the protrusions being situated over approximately 180 degrees of a cross-section of the blank, the cross-section being perpendicular to the longitudinal axis.

The handle may be formed from a flat blank. The handle may be formed by at least one of injection molding and machining. The protrusions may extend radially away from the longitudinal axis, and may end in a flat gripping end. The protrusions may be evenly spaced apart from each other along the longitudinal axis, and the protrusions may be spaced apart from each other over the approximately 180 degrees of the cross-section of the blank. The handle may include apertures in the blank between the protrusions, and may include a locking element configured to maintain the handle in a closed position.

According to an exemplary embodiment of the present invention, a device includes a first component formed of a blank extending substantially along a longitudinal axis of the device between a distal end and a proximal end of the device, a second component formed of a blank extending substantially along the longitudinal axis of the device between the distal end and the proximal end of the device, the first component and the second component pivotally coupled together, and protrusions situated on at least a portion of the blanks of the first and second components, the protrusions being situated over approximately 180 degrees of a cross-section of each blank, the cross-section being perpendicular to the longitudinal axis.

In a closed position, the protrusions may be situated over approximately 360 degrees of the cross-section of blanks of the first and second components taken together, thereby forming a substantially round handle in cross-section. The device may include locking elements associated with each of the first and second components, the locking elements configured to maintain the handle in a closed position.

According to an exemplary embodiment of the present invention, a method of making a handle for a device, the device including a blank extending substantially along a longitudinal axis of the device between a distal end and a proximal end of the device, includes forming protrusions on at least a portion of the blank, the protrusions being formed over approximately 180 degrees of a cross-section of the blank, the cross-section being perpendicular to the longitudinal axis.

The handle may be formed from a flat blank. The handle may be formed by at least one of injection molding and machining. The protrusions may extend radially away from the longitudinal axis, and may end in a flat gripping end. The protrusions may be evenly spaced apart from each other along the longitudinal axis, and the protrusions may be spaced apart from each other over the approximately 180 degrees of the cross-section of the blank. Apertures may be formed in the blank between the protrusions, and a locking element may be formed on the blank, the locking element configured to maintain the handle in a closed position.

Other features and aspects of example embodiments of the present invention are described in more detail below with reference to the appended Figures.

### BRIEF DESCRIPTION OF THE DRAWINGS

FIG. 1 illustrates a perspective view of a medical instrument, in a closed position, according to an exemplary embodiment of the present invention.

FIG. 2 illustrates a left side view of the instrument shown in FIG. 1.

FIG. 3 illustrates a right side view of the instrument shown in FIG. 1.

FIG. 4 illustrates a bottom view of the instrument shown in FIG. 1.

FIG. 5 illustrates a top view of the instrument shown in FIG. 1.

FIG. 6 illustrates a front view of the instrument shown in FIG. 1.

FIG. 7 illustrates a rear view of the instrument shown in FIG. 1.

FIG. 8 illustrates a perspective view of a medical instrument, in an open position, according to an exemplary embodiment of the present invention.

FIG. 9 illustrates a left side view of the instrument shown in FIG. 8.

FIG. 10 illustrates a right side view of the instrument shown in FIG. 8.

FIG. 11 illustrates a bottom view of the instrument shown in FIG. 8.

FIG. 12 illustrates a top view of the instrument shown in FIG. 8.

FIG. 13 illustrates a front view of the instrument shown in FIG. 8.

FIG. 14 illustrates a rear view of the instrument shown in FIG. 8.

### DETAILED DESCRIPTION

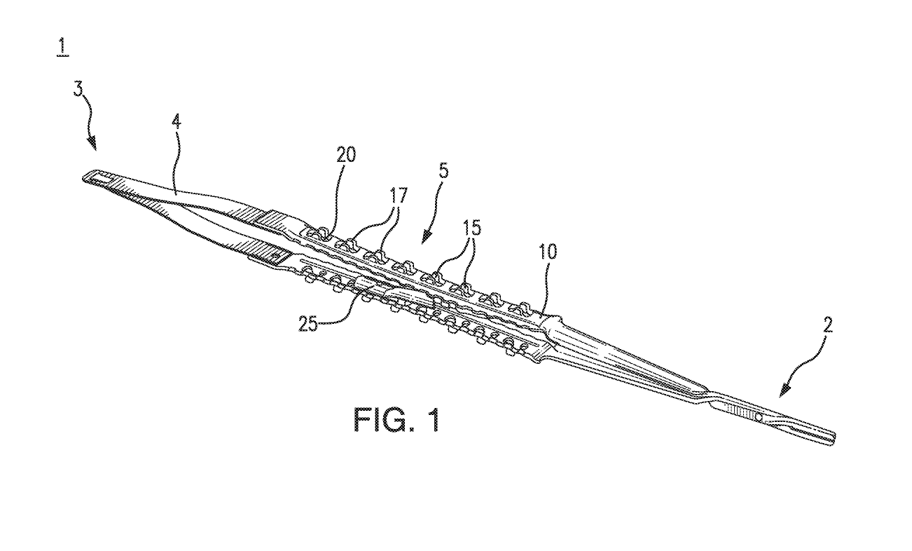

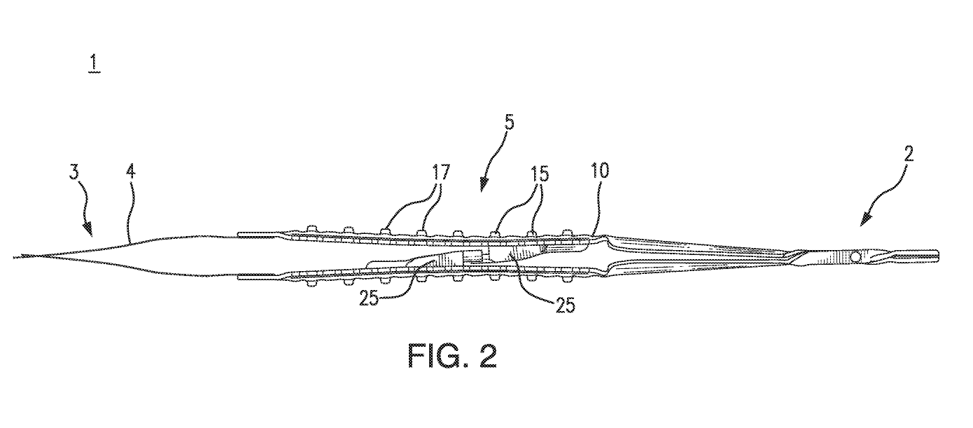

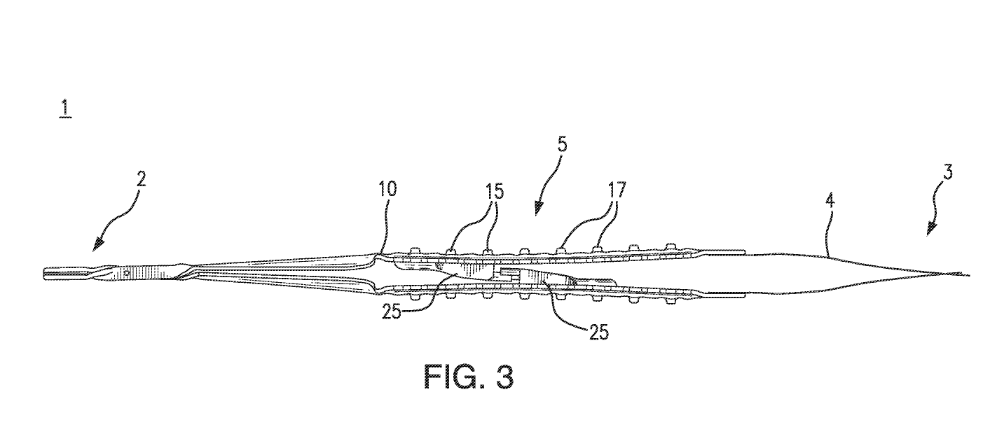

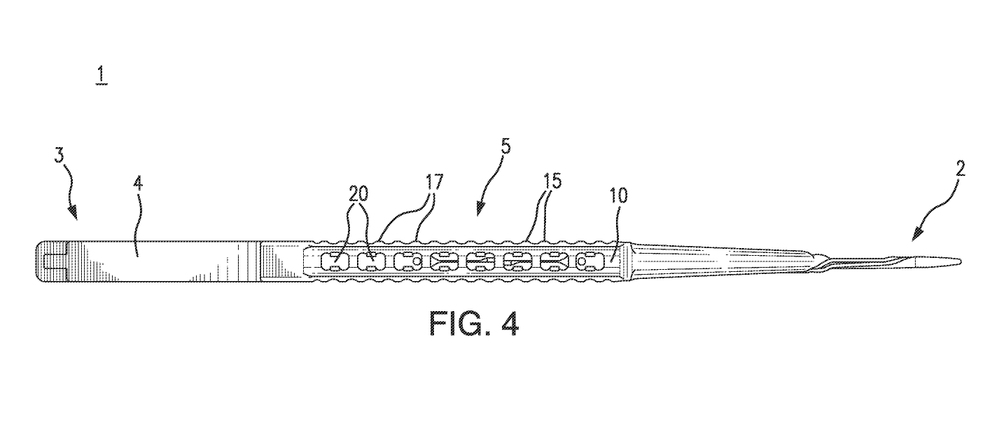

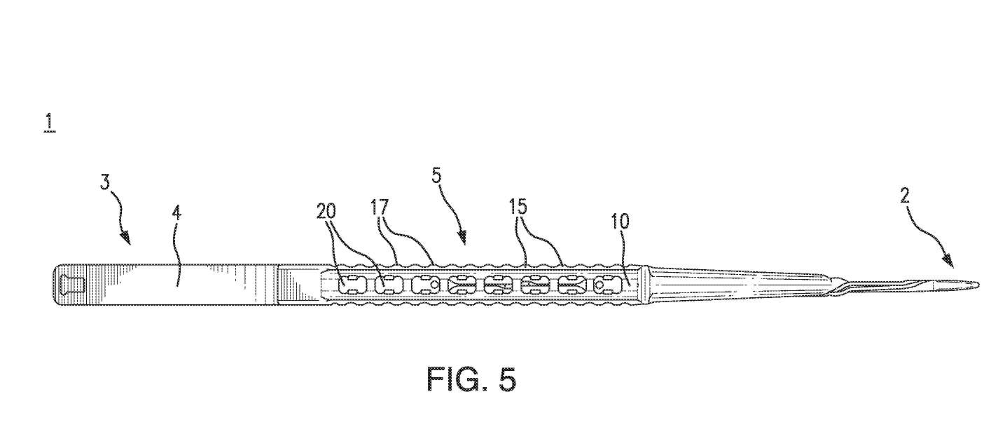

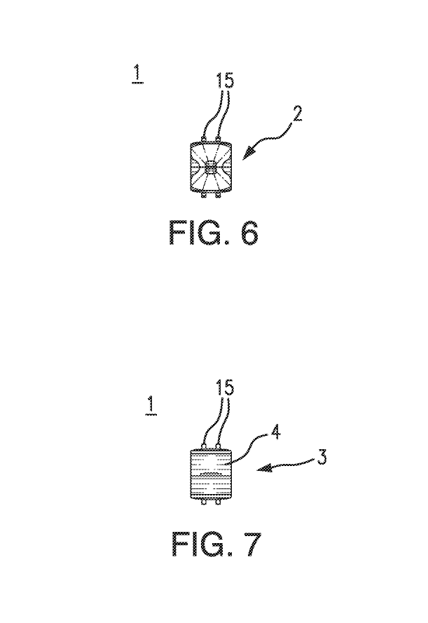

FIG. 1 illustrates a perspective view of a medical instrument 1, in a closed position, according to an exemplary embodiment of the present invention. FIGS. 2 to 7 illustrate left side, right side, bottom, top, front, and rear views of the instrument 1 shown in FIG. 1.

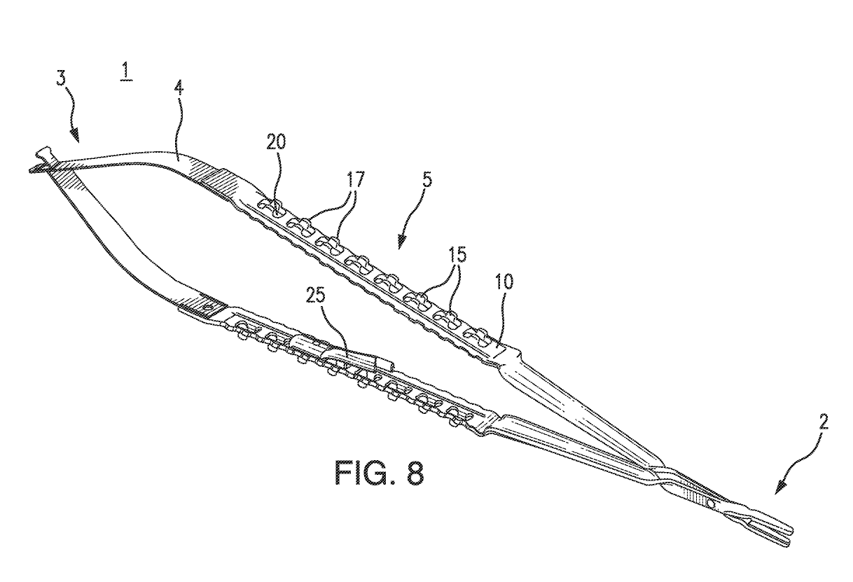

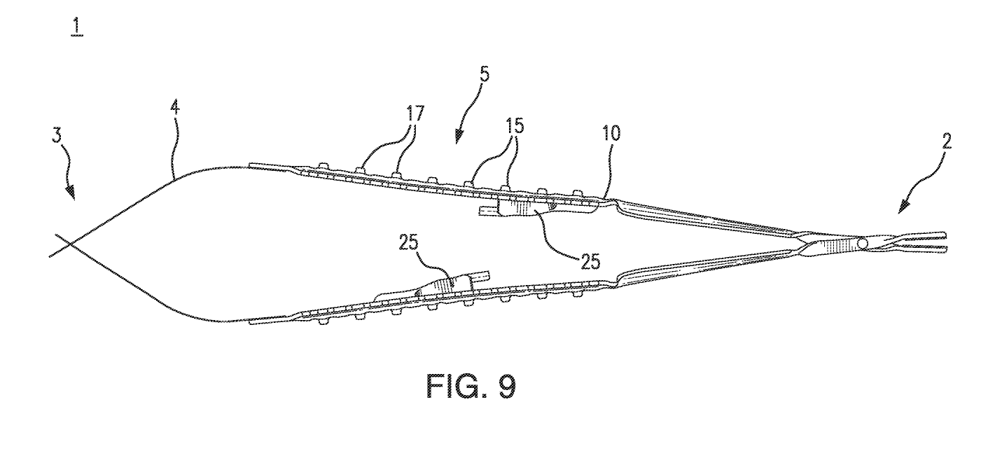

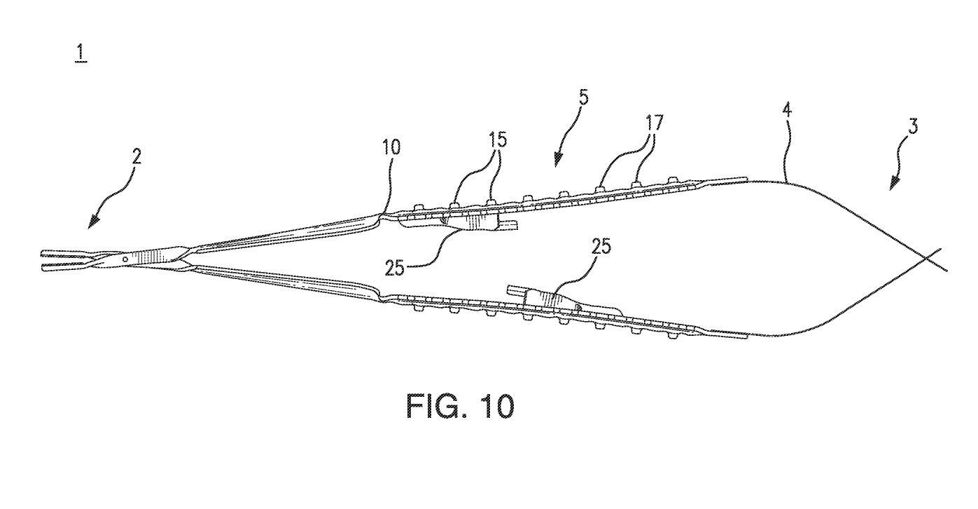

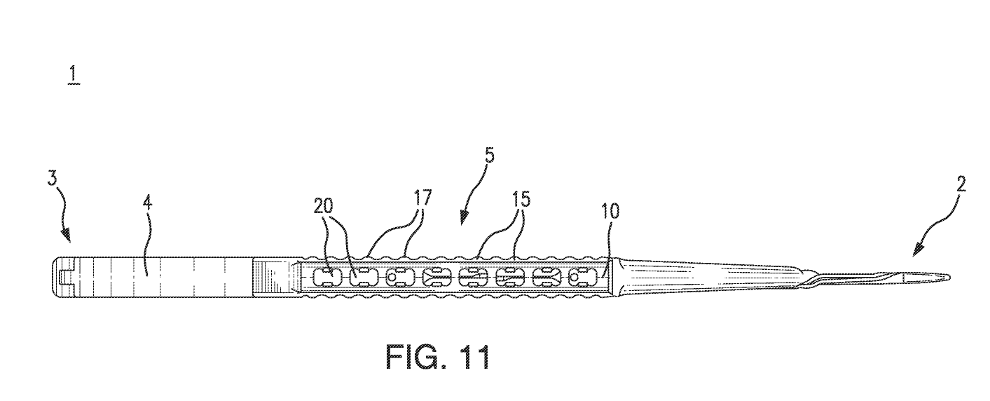

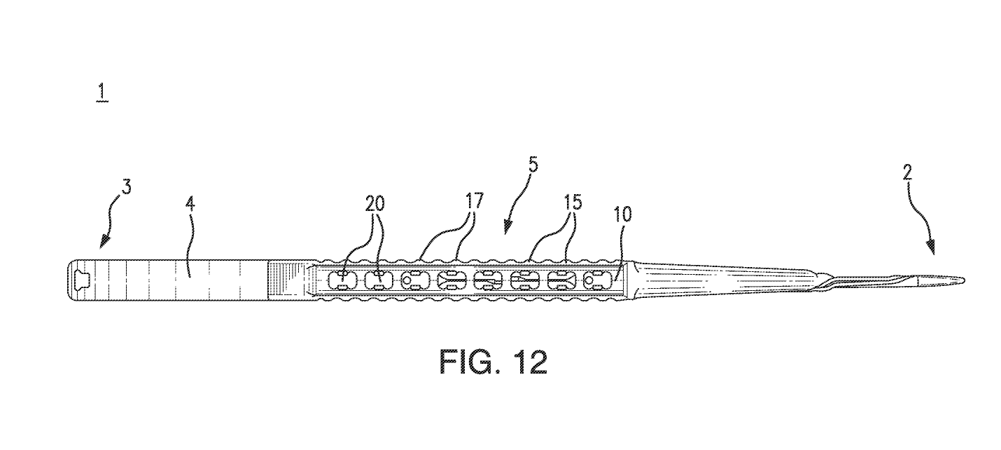

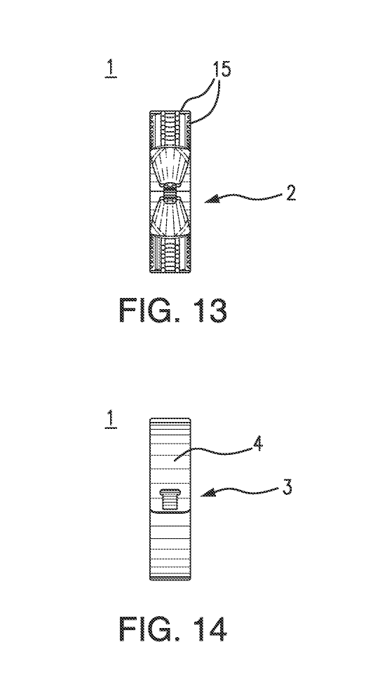

FIG. 8 illustrates a perspective view of a medical instrument 1, in an open position, according to an exemplary embodiment of the present invention. FIGS. 9 to 14 illustrate left side, right side, bottom, top, front, and rear views of the instrument 1 shown in FIG. 8.

The instrument 1 includes two handles 5 that extend substantially along a longitudinal axis of the instrument 1 between a distal end 2 and a proximal end 3 of the instrument 1. Although the Figures illustrate a particular embodiment of spring-like elements 4 at the proximal end 3, alternative embodiments may include at the proximal end 3 other shapes, designs and/or configurations of springs, connectors, and/or instrument ends. In addition, although the Figures illustrate a particular embodiment of forceps at the distal end 2, alternative embodiments may include at the distal end 2 other shapes, designs and/or configurations of forceps, scissors, needle holders, cutting blades, grasping arms, and/or other medical manipulators. Further, the handles 5 may be pivotally joined at or near the distal end 2, or between the distal end 2 and the handles 5.

The distal end 2 may be made of a material that resiliently flexes during use, for example, 300 series spring steel. The distal end 2 may be made from flexibly resilient, medical grade materials having any or all the features described in U.S. Pat. Nos. 4,527,331; 6,592,603; and 7,497,867, which are expressly incorporated herein in their entireties by reference thereto. Alternatively, the distal end 2 may be made of flexible steel, 400 series steel, flexible carbon, flexible plastic, and/or flexible coating materials.

The proximal end 3 may be made of a material that resiliently flexes during use, for example, 300 series spring steel. The proximal end 3 may be made from flexibly resilient, medical grade materials having any or all the features described in U.S. Pat. Nos. 4,527,331; 6,592,603; and 7,497,867, which are expressly incorporated herein in their entireties by reference thereto. Alternatively, the proximal end 3 may be made of flexible steel, 400 series steel, flexible carbon, flexible plastic, and/or flexible coating materials.

Each handle 5 is formed from a blank 10. The blank 10 may be a substantially flat blank. Along at least a portion of the length of the blank 10, the handle 5 includes protrusions 15. The protrusions 15 may extend substantially radially away from the longitudinal axis of the instrument 1. The protrusions 15 may be formed such that, when taking a cross-section of the blank 10 perpendicular to the longitudinal axis of the instrument 1, the protrusions 15 cover approximately 180 degrees of the cross-section of the blank 10. That is, the protrusions 15 cover approximately half of an outer surface of the blank 10, i.e., the portion of the outer surface that would come in contact with a user's hand and/or fingers.

The protrusions 15 may end in a flat gripping end 17 that facilitates a secure grip and tactile feedback for the user. Alternatively, other shapes, designs and/or configurations of the gripping end 17 may be used such as, for example, rounded, pointed, smooth, rough, and/or others.

The protrusions 15 may be spaced apart, e.g., evenly spaced apart, from each other along the longitudinal axis of the instrument 1. In addition, the protrusions 15 may be spaced apart, e.g., evenly spaced apart, from each other over the approximately 180 degrees of the cross-section of the blank 10. Further, the protrusions 15 may be separated from each other by apertures 20 in the blank 10.

The handle 5 may be formed by injection molding, machining, and/or other forming processes. For example, the protrusions 15 may be formed by stamping, raising, punching, pressing, and/or flat-pressing the blank 10. In addition, the apertures 20 may be formed separately from, or as a consequence of, the operations for forming the protrusions 15.

The blank 10 may be made of a material that resiliently flexes during use, for example, 300 series spring steel. The blank 10 may be made from flexibly resilient, medical grade materials having any or all the features described in U.S. Pat. Nos. 4,527,331; 6,592,603; and 7,497,867, which are expressly incorporated herein in their entireties by reference thereto. Alternatively, the blank 10 may be made of flexible steel, 400 series steel, flexible carbon, flexible plastic, and/or flexible coating materials.

Further, each handle 5 may include a locking element 25 that engages with a corresponding locking element 25 of a corresponding, pivotally connected handle 5. The locking elements 25 may be configured to lock the instrument 1 in a closed position when the handles 5 are pushed toward each other such that the locking elements 25 engage with each other. In order to unlock the instrument 1, the handles 5 may be pushed further toward each other, thereby disengaging the locking elements 25 from each other so that the instrument 1 returns to an open position. In particular, upon movement of the handles 5 toward each other, one locking element 25 may include a detent or groove in which the corresponding locking element 25 is held, against the opening force of the springs 4, thereby locking the instrument 1 in a closed position. Upon further movement of the handles 5 toward each other, the corresponding locking element 25 may become disengaged from the detent or groove of the one locking element 25 so that the instrument 1 may return to an open position under the opening force of the springs 4.

When in a closed position, the handles 5 may form a substantially round cross-section. That is, in the closed position, the protrusions 15 may be situated over approximately 360 degrees of the cross-section of the blanks 10 of the handles 5 taken together, thereby forming a substantially round cross-section.

During use of the instrument 1 by a user, the protrusions 15 may facilitate more secure gripping and more precise control of the instrument 1. The protrusions 15 may provide greater tactile feedback to a user such that the user is aware of the position and/or orientation of the instrument 1 without having to resort to visual confirmation. Moreover, when the instrument 1 is maintained in a closed position by locking elements 25, the substantially round cross-section of the handles 5 having protrusions 15 may provide the user with the ability to rotate and/or otherwise manipulate the instrument 1 with ease while ensuring greater control over such movement, including more precise control over fine movements that may be necessary during medical procedures.

A medical instrument 1 may include a first component formed of a blank 10. extending substantially along a longitudinal axis of the instrument 1 between a distal end 2 and a proximal end 3 of the instrument 1, and a second component formed of a blank 10 extending substantially along the longitudinal axis of the instrument 1 between the distal end 2 and the proximal end 3 of the instrument 1. The first and second components may be pivotally coupled together to form a medical instrument 1, such as for example, scissors, forceps, needle holders and other medical instruments. Protrusions 15 may be situated on at least a portion of the handles 5 of the blanks 10 of the first and second components, the protrusions 15 being situated over approximately 180 degrees of a cross-section of each blank 10, the cross-section being perpendicular to the longitudinal axis.

A method of making a handle 5 for an instrument 1 having a blank 10 extending substantially along a longitudinal axis of the instrument 1 between a distal end 2 and a proximal end 3 of the instrument 1 includes forming protrusions 15 on at least a portion of the blank 10.

Each handle 5 is formed from a blank 10. The blank 10 may be a substantially flat blank. Along at least a portion of the length of the blank 10, the protrusions 15 are formed on the handle 5. The protrusions 15 may extend substantially radially away from the longitudinal axis of the instrument 1. The protrusions 15 may be formed such that, when taking a cross-section of the blank 10 perpendicular to the longitudinal axis of the instrument 1, the protrusions 15 cover approximately 180 degrees of the cross-section of the blank 10. That is, the protrusions 15 cover approximately half of an outer surface of the blank 10, i.e., the portion of the outer surface that would come in contact with a user's hand and/or fingers.

The protrusions 15 may end in a flat gripping end 17 that facilitates a secure grip and tactile feedback for the user. Alternatively, other shapes, designs and/or configurations of the gripping end 17 may be used such as, for example, rounded, pointed, smooth, rough, and/or others.

The protrusions 15 may be spaced apart, e.g., evenly spaced apart, from each other along the longitudinal axis of the instrument 1. In addition, the protrusions 15 may be spaced apart, e.g., evenly spaced apart, from each other over the approximately 180 degrees of the cross-section of the blank 10. Further, apertures 20 may be formed in the blank 10 between the protrusions 15.

The handle 5 may be formed by injection molding, machining, and/or other forming processes. For example, the protrusions 15 may be formed by stamping, raising, punching, pressing, and/or flat-pressing the blank 10. In addition, the apertures 20 may be formed separately from, or as a consequence of, the operations for forming the protrusions 15.

Further, a locking element 25 may be formed on each handle 5 that engages with a corresponding locking element 25 of a corresponding, pivotally connected handle 5. The locking elements 25 may be configured to lock the instrument 1 in a closed position when the handles 5 are pushed toward each other such that the locking elements 25 engage with each other. In order to unlock the instrument 1, the handles 5 may be pushed further toward each other, thereby disengaging the locking elements 25 from each other so that the instrument 1 returns to an open position.

When in a closed position, the handles 5 may form a substantially round cross-section. That is, in the closed position, the protrusions 15 may be situated over approximately 360 degrees of the cross-section of the blanks 10 of the handles 5 taken together, thereby forming a substantially round cross-section.

During use of the instrument 1 by a user, the protrusions 15 may facilitate more secure gripping and more precise control of the instrument 1. The protrusions 15 may provide greater tactile feedback to a user such that the user is aware of the position and/or orientation of the instrument 1 without having to resort to visual confirmation. Moreover, when the instrument 1 is maintained in a closed position by locking elements 25, the substantially round cross-section of the handles 5 having protrusions 15 may provide the user with the ability to rotate and/or otherwise manipulate the instrument 1 with ease while ensuring greater control over such movement, including more precise control over fine movements that may be necessary during medical procedures.

In addition to the above described exemplary embodiments, other useful devices may also be manufactured according to the exemplary method of the present invention. Further, although the above described embodiments have been shown with a particular shape, size, and other features, the above embodiments are described by way of example only.

It is apparent that many modifications and variations of this invention as hereinabove set forth may be made without departing from the spirit and scope hereof. The specific embodiments described are given by way of example only, and the invention is limited only by the terms of the appended claims.

What is claimed is:

1. A handle for a device, comprising:
a blank extending substantially along a longitudinal axis of the device between a distal end and a proximal end of the device; and
protrusions situated on at least a portion of the blank, the protrusions being situated over approximately 180 degrees of a cross-section of the blank, the cross-section being perpendicular to the longitudinal axis.

2. The handle according to claim 1, wherein the handle is formed from a flat blank.

3. The handle according to claim 1, wherein the handle is formed by at least one of injection molding and machining.

4. The handle according to claim 1, wherein the protrusions extend radially away from the longitudinal axis.

5. The handle according to claim 1, wherein the protrusions end in a flat gripping end.

6. The handle according to claim 1, wherein the protrusions are evenly spaced apart from each other along the longitudinal axis.

7. The handle according to claim 1, wherein the protrusions are spaced apart from each other over the approximately 180 degrees of the cross-section of the blank.

8. The handle according to claim 1, further comprising apertures in the blank between the protrusions.

9. The handle according to claim 1, further comprising a locking element configured to maintain the handle in a closed position.

10. A device, comprising:
a first component formed of a blank extending substantially along a longitudinal axis of the device between a distal end and a proximal end of the device;
a second component formed of a blank extending substantially along the longitudinal axis of the device between the distal end and the proximal end of the device, the first component and the second component pivotally coupled together; and
protrusions situated on at least a portion of the blanks of the first and second components, the protrusions being situated over approximately 180 degrees of a cross-section of each blank, the cross-section being perpendicular to the longitudinal axis.

11. The device according to claim 10, wherein in a closed position, the protrusions are situated over approximately 360 degrees of the cross-section of blanks of the first and second components taken together, thereby forming a substantially round handle in cross-section.

12. The device according to claim 10, further comprising locking elements associated with each of the first and second components, the locking elements configured to maintain the handle in a closed position.

13. A method of making a handle for a device, the device including a blank extending substantially along a longitudinal axis of the device between a distal end and a proximal end of the device, comprising:
forming protrusions on at least a portion of the blank, the protrusions being formed over approximately 180 degrees of a cross-section of the blank, the cross-section being perpendicular to the longitudinal axis.

14. The method according to claim 13, wherein the handle is formed from a flat blank.

15. The method according to claim 13, wherein the handle is formed by at least one of injection molding and machining.

16. The method according to claim 13, wherein the protrusions extend radially away from the longitudinal axis.

17. The method according to claim 13, wherein the protrusions end in a flat gripping end.

18. The method according to claim 13, wherein the protrusions are evenly spaced apart from each other along the longitudinal axis.

19. The method according to claim 13, wherein the protrusions are spaced apart from each other over the approximately 180 degrees of the cross-section of the blank.

20. The method according to claim 13, wherein apertures are formed in the blank between the protrusions.

21. The method according to claim 13, further comprising forming a locking element on the blank, the locking element configured to maintain the handle in a closed position.
